(19) United States
(12) Patent Application Publication
(10) Pub. No.: US 2020/0019941 A1
(43) Pub. Date: Jan. 16, 2020

(54) SYSTEMS AND METHODS FOR FACILITATING PAYMENT BY INSTALLMENTS

(71) Applicant: MASTERCARD INTERNATIONAL INCORPORATED, Purchase, NY (US)

(72) Inventor: Shruti RAMNANI, Pune (IN)

(21) Appl. No.: 16/440,402

(22) Filed: Jun. 13, 2019

(30) Foreign Application Priority Data
Jul. 16, 2018 (SG) 10201806079R

(51) Int. Cl. G06Q 20/10; G06Q 20/32; G06Q 20/34; G06Q 20/20

(52) U.S. Cl. CPC G06Q 20/102; G06Q 20/3221; G06Q 20/105; G06Q 20/204; G06Q 20/341

(57) ABSTRACT

A data processing system for processing transaction data to determine eligibility of a group of transactions for payment by installments includes a data storage device storing instructions operative by a processor to: receive a plurality of transaction indications, each indicating a transaction on a payment card account and comprising indications of the payment card account, merchant, transaction amount and a time and/or date of that transaction; compare the transaction amount of each transaction with an installment threshold; store the transaction indication in a database if the transaction amount of that transaction is less than the installment threshold; and for all transaction indications stored in the database, group transactions that meet a grouping rule to form a transaction group; for each transaction group, determine a group transaction amount as a total of the transaction amounts; compare the group transaction amount with the installment threshold; and generate an installment qualification indication that indicates the group of transactions.

### TECHNICAL FIELD

The present disclosure relates to transaction payment transaction processing systems and methods and in particular to the provision of options to pay for payment card transactions by installments.

### BACKGROUND

Many payment card issuing organizations provide cardholders of payment cards such as credit cards with options to pay for transactions by installments. Typically certain transactions are identified by either the issuer of the payment card or by a payment network which processes payment transactions. The identification of whether payment transactions are eligible for payment by installments may be based on criteria specified by the issuer of the payment card such as if the transaction amount exceeds a threshold, or if the amount falls into a specified range. If a payment transaction meets the criteria, then the cardholder is presented with the option to pay for the transaction in installments.

Typically, if the cardholder elects to pay for a transaction in installments, they will be offered a lower interest rate than would be applied to a payment card bill for general transactions.

In known systems and methods for offering options to a cardholder to pay in installments, the eligibility to pay by installments is determined on a transaction basis. For example, U.S. Pat. No. 9,785,933 describes systems and methods for processing credit card transactions. The system includes a “clearing service” which detects transactions that are eligible for an installment offer. The eligibility of transactions for an installment offer is determined based on criteria set by an issuing bank. US Patent Application 2006/0229965 describes a system in which a purchaser may be offered an installment plan at a point of sale (POS) terminal. The purchaser may be given the option to pay in full or to pay in installments by the POS terminal. A central controller of the system determines whether to allow installment payments based on the purchase price or other factors such as whether the account has been preapproved for installment payments. PCT Patent Application WO2016/176535 describes a system and method for processing payment transactions which includes the option of allowing payment by installments. In response to receiving a transaction authorization request, a financial institution associated with a primary account number generates a response message which includes an indication that the transaction is eligible for payment by installments.

In each of the systems mentioned above, a determination on whether to offer a cardholder an option to pay by installments is made based on a transaction basis. This limits the availability of payment by installments. It may be the case, for example that a cardholder makes multiple transactions at a given merchant which when combined would qualify for installments, but do not meet the qualification criteria for installments as individual transactions. The systems mentioned above do not allow payment by installments to be offered to a cardholder in such a scenario.

It is therefore an aim of the present disclosure to broaden the availability of payment for a transaction in installments.

### BRIEF SUMMARY

According to a first aspect of the present disclosure, a data processing system for processing transaction data to determine eligibility of a group of transactions for payment by installments is provided. The data processing system comprises: a computer processor and a data storage device, the data storage device storing instructions operative by the processor to: receive a first transaction indication, the first transaction indication indicating a first transaction on a payment card account and comprising an indication of the payment card account, an indication of a merchant, an indication of a transaction amount and an indication of a time and/or date of the first transaction; compare the transaction amount of the first transaction with an installment threshold, the installment threshold indicating a minimum amount for a transaction to qualify for payment by installments; store the first transaction indication in a database if the transaction amount of the first transaction is less than the installment threshold; receive a second transaction indication, the second transaction indication indicating a second transaction on the payment card account and comprising an indication of the payment card account, an indication of a merchant, an indication of a transaction amount and an indication of a time and/or date of the second transaction; compare the transaction amount of the second transaction with an installment threshold, the installment threshold indicating a minimum amount for a transaction to qualify for payment by installments; store the second transaction indication in a database if the transaction amount of the second transaction is less than the installment threshold; perform a grouping operation, the grouping operation comprising, for all transaction indications stored in the database, grouping transactions for the payment card account which meet a grouping rule to form a transaction group; determine a group transaction amount as the total of the transaction amounts of the transactions of the transaction group; compare the group transaction amount with the installment threshold; and generate an installment qualification indication comprising an indication of the group of transactions.

In an embodiment, the grouping rule comprises a time period wherein transactions having a transaction time and/or date within the time period are included in the transaction group.

The grouping operation may comprise grouping transactions according to the merchant identifier.

In an embodiment, the grouping rule comprises an indication of a list of merchants, wherein transactions corresponding to merchants on the list of merchants are included in the transaction group.

In an embodiment, the data storage device stores instructions operative by the processor to determine an issuer of the payment card and look up a grouping rule and/or an installment threshold specified by the issuer of the payment card.

In an embodiment, the first transaction indication and the second transaction indication comprise transaction authorization responses.

In an embodiment, the data storage device stores instructions operative by the processor to send the installment qualification indication to a server associated with an issuer of the payment card.

In an embodiment, the data storage device stores instructions operative by the processor to delete indications of transactions included in the group of transactions from the transaction database.

In an embodiment, the data storage device stores instructions operative by the processor to delete indications of transactions from the transaction database if a time and/or date falls outside a time period over which transactions are grouped.

In an embodiment, the data storage device stores instructions operative by the processor to perform the grouping operation at regular intervals.

According to a second aspect of the present disclosure, a method of processing transaction data is provided. The method comprises: receiving a first transaction indication, the first transaction indication indicating a first transaction on a payment card account and comprising an indication of the payment card account, an indication of a merchant, an indication of a transaction amount and an indication of a time and/or date of the first transaction; comparing the transaction amount of the first transaction with an installment threshold, the installment threshold indicating a minimum amount for a transaction to qualify for payment by installments; storing the first transaction indication in a database if the transaction amount of the first transaction is less than the installment threshold; receiving a second transaction indication, the second transaction indication indicating a second transaction on the payment card account and comprising an indication of the payment card account, an indication of a merchant, an indication of a transaction amount and an indication of a time and/or date of the second transaction; comparing the transaction amount of the second transaction with an installment threshold, the installment threshold indicating a minimum amount for a transaction to qualify for payment by installments; storing the second transaction indication in a database if the transaction amount of the second transaction is less than the installment threshold; performing a grouping operation, the grouping operation comprising, for all transaction indications stored in the database, grouping transactions for the payment card account which meet a grouping rule to form a transaction group; determining a group transaction amount as the total of the transaction amounts of the transactions of the transaction group; comparing the group transaction amount with the installment threshold; and generating an installment qualification indication comprising an indication of the group of transactions.

In accordance with a third aspect of the present invention, a non-transitory computer-readable medium is provided. The computer-readable medium has stored thereon program instructions for causing at least one processor to perform the preceding method.

### BRIEF DESCRIPTION OF THE DRAWINGS

Embodiments of the invention will now be described for the sake of example only, with reference to the following drawings in which:

FIG. 1 shows a system for processing payment transactions for facilitating payment by installments according to an embodiment of the present invention;

FIG. 2 is a flow chart showing a method of processing a transaction indication according to an embodiment of the present invention;

FIG. 3 is a flow chart showing a method of determining eligibility of a group of transactions for payment by installments according to an embodiment of the present invention;

FIG. 4 is a block diagram showing a functional structure of an installment platform server according to an embodiment of the present invention;

FIG. 5 is a flowchart showing a method of processing payment transaction indications to determine eligibility of a group of transactions for payment by installments according to an embodiment of the present invention;

FIG. 6 shows an example of grouped transactions processed in an embodiment of the present invention;

FIG. 7 is a block diagram showing issuer specified information used a method of determining eligibility of a group of transactions for payment by installments according to an embodiment of the present invention; and

FIG. 8 is a block diagram showing a technical architecture of an installment platform server according to an embodiment of the present invention.

### DETAILED DESCRIPTION

As used in this disclosure, the term “institution” is used in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in disclosure, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

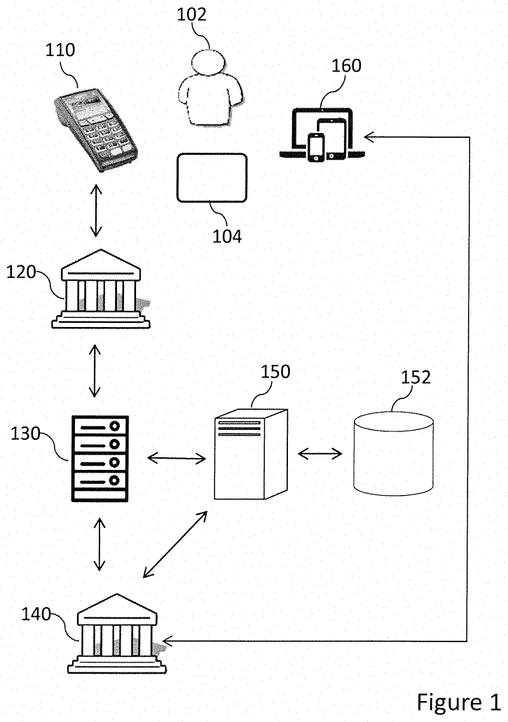

FIG. 1 shows a system 100 for processing payment transactions for facilitating payment by installments according to an embodiment of the present invention. The system 100 comprises a merchant point-of-sale (POS) terminal 110, an acquirer server 120, a payment network server 130, and an issuer server 140. An installment platform server 150 is coupled to the payment network server 130 and the issuer server 140. The installment platform server 150 is coupled to a transaction indication database 152. A cardholder 102 can make payment transactions using a payment card 104, which in the embodiments described herein is a credit card. A cardholder user device 160 such as a smartphone, tablet, or personal computer is associated with the cardholder 102.

As will be described in more detail below, the system 100 processes payment transactions made by the cardholder 102 using the payment card 104. During the processing of the transactions, the installment platform server 150 identifies transactions, or groups of transactions which are eligible for payment by installments and sends an indication of such transactions or groups of transactions to the issuer server 140. The issuer server 140 presents the user 102 with notification that the transaction or group of transactions may be paid in installments. This notification may be send by the issuer server 140 to the cardholder user device 160 as an electronic message such as a text message, an email message or a push notification to an application running on the cardholder user device 160.

The payment network server 130 facilitates a payment transaction between the cardholder 102 and a merchant which operates the merchant POS terminal 110. The payment network server 130 is a server associated with a payment network such as the Banknet payment network operated by Mastercard. As shown in FIG. 1, the payment network server 130 is in communication with the acquirer server 120 and the issuer server 140. The acquirer server 120 is operated by an acquirer institution at which the merchant maintains a merchant account to receive funds. The issuer server 140 is associated with an issuer institution which maintains at least a customer account which can be used for payment in payment transactions (e.g. card-not-present payment transactions using an e-commerce website or physical in-store payment transactions at the merchant point-of-sale (POS) terminal 110).

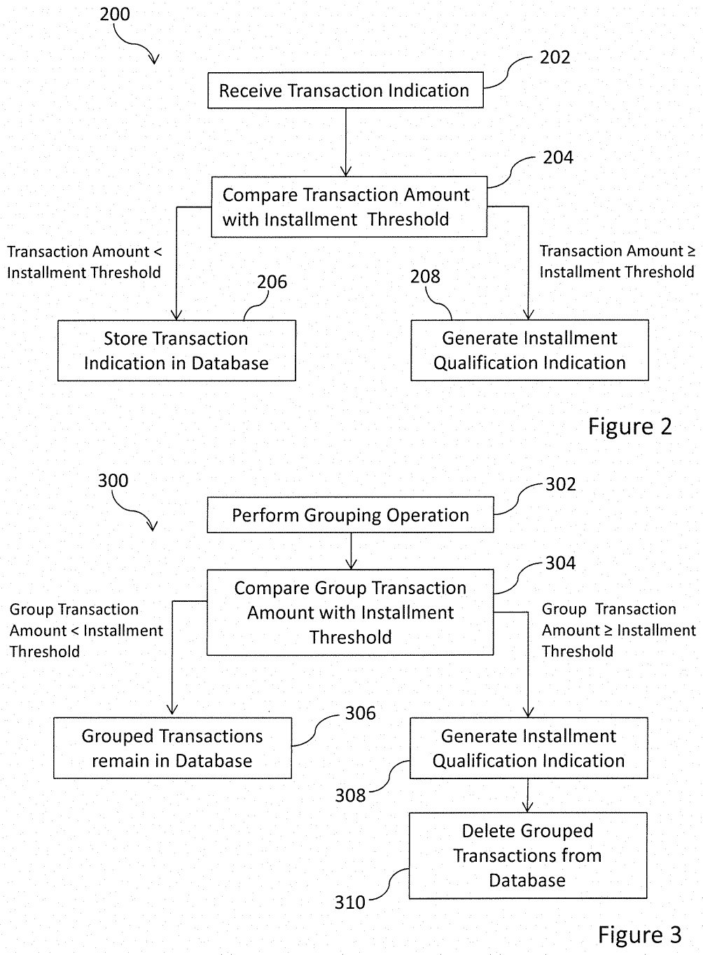

The present invention aims to improve upon the processing of offering payments by installment to the cardholder 102 by issuer server 140. This is facilitated by the installment platform server 150 and the transaction indication database 152. The operation of the installment platform server 150 will now be described as part of the processing of a transaction with reference to FIGS. 2 and 3.

In order to process a payment transaction associated with the merchant POS terminal 110, a payment transaction authorization request is transmitted from the merchant POS terminal 110 to the payment network server 130 via the acquirer server 120. The payment transaction authorization request comprises an account identifier such as a credit card number associated with the payment card 104 and a payment amount, the payment transaction authorization request may also comprise an indication of the merchant, for example a Merchant identifier and an indication of a time and/or date associated with the transaction. Other information may also be included in the payment transaction authorization request, for example, a card verification code (CVC), a name of the cardholder, an expiry date of the payment card etc. Upon receiving the payment transaction authorization request from merchant POS terminal 110, the payment network server 130 is typically required to request authorization from the issuer server 140 in order to proceed with the payment transaction. The request for authorization comprises at least the customer account identifier and the payment amount. Typically, the request for authorization may comprise the CVC and the expiry date of the payment card.

In order to authorize the payment transaction, the issuer server 140 is configured to verify the CVC code and/or the expiry date of the payment card etc. The issuer server 140 may also be configured to check an available balance of the customer account associated with the customer account to determine if the available credit balance is more than the payment amount. The issuer server 140 then authorizes the payment transaction if the relevant details are verified and the available credit balance is equal to or more than the payment amount.

A payment transaction authorization response is generated and sent by the issuer server 140 to the merchant POS terminal 110 via the payment network server 130.

The payment transaction authorization response comprises details of the payment transaction such as an identifier of the merchant, the primary account number (PAN) of the payment card, the transaction amount of the transaction and the transaction time and/or date. As well as being sent to the merchant POS terminal 110, the payment transaction authorization response is also sent to the installment platform server 150. The installment platform server 150 processes the payment transaction authorization response and generates an installment qualification indication if the payment transaction or a group of payment transactions qualify for payment by installments

FIG. 2 is a flow chart showing a method of processing a transaction indication according to an embodiment of the present invention. The method 200 shown in FIG. 2 is carried out by the installment platform server 150.

In step 202, the installment platform server 150 receives a transaction indication from the payment network server 130. As described above, the transaction indication may be a payment transaction authorization response. The transaction indication comprises details of the transaction, such as the primary account number (PAN) associated with the transaction, the transaction amount and the time and/or date of the transaction. The transaction indication may comprise additional details of the transaction such as an identifier of the merchant associated with the transaction. It is noted that a transaction authorization response formatted according to the ISO 8583 standard includes such information.

In step 204, the installment platform server 150 compares the transaction amount from the transaction indication with an installment threshold. The installment threshold is typically set by the issuer institution. If the transaction amount is less than the installment threshold then the method moves to step 206. If the transaction amount is greater than or equal to the installment threshold, then the method moves to step 208.

In step 206, the installment platform server 150 stores the transaction indication in the transaction database 152. Thus, the transaction database 152 stores transaction indications for transactions which do not on their own qualify for payment by installments.

In step 208, the installment platform server 150 generates an installment qualification indication for the transaction when the transaction qualifies for payment by installments. The installment qualification indication generated in step 208 may comprise an indication of the transaction amount and transaction details associated with the transaction.

The installment qualification indication generated in step 208 is sent to the issuer server 140. The issuer server 140 then generates an indication which is sent to the cardholder 102. The indication may be sent as a text message, email message, or push message to an application running on the cardholder user device 160.

As described above, the transactions which do not qualify for payment by installments are stored in the transaction database 152. The installment platform server 150 a grouping operation to group the non-qualifying transactions and then determines if a group of transactions would qualify for payment by installments. This operation is described in more detail with reference to FIG. 3 below. The grouping operation may be performed at specific intervals such as on a daily basis, or may be performed in response to receiving transaction indications by the installment platform server 150.

FIG. 3 is a flow chart showing a method of determining eligibility of a group of transactions for payment by installments according to an embodiment of the present invention. The method 300 is performed by the installment platform server 150 on the transaction indications stored in the transaction database 152.

In step 302, the installment platform server 150 performs a grouping operation on transactions stored in the transaction database 152. The grouping transaction may involve grouping all transactions for a given primary account number (PAN), which occurred within a given time period, according to the merchant at which the transactions took place. Thus, if the cardholder 102 made several separate transactions within the time period at one merchant using the same payment card, those transactions would be grouped together. In some embodiments, transactions carried out at more than one merchant may be grouped. For example, transactions made at different stores belonging to the same chain may be grouped, or transactions made at different stores within a shopping mall may be grouped. The rules for grouping transactions may be specified by the issuer institution. Such rules may specify the time period over which transactions may be grouped and also whether transactions at more than one merchant may be grouped. The grouping operation may take place on a periodic basis for example as a batch job carried out at the end of each day. The scheduling of such a batch job may be specified by the issuer institution, so for example the batch job for certain issuers may take place every 8 hours or daily whereas the batch job for other issuers may take place on a weekly basis.

In step 304, the installment platform server 150 compares the group transaction amount with the installment threshold. The installment threshold is typically set by the issuer institution. If the group transaction amount is less than the installment threshold then the method moves to step 306. If the group transaction amount is greater than or equal to the installment threshold, then the method moves to step 308.

In step 306 which occurs if the group transaction amount is less than the installment threshold, the grouped transactions remain in the transaction database 152. If further transactions are made by the cardholder 102 using the payment card 104 then these transaction may then be grouped with the transactions already stored in the transaction database 152.

In step 308, the installment platform server 150 generates an installment qualification indication. The installment qualification indication comprises an indication of the grouped transactions, for example as may comprise an indication of the transaction amount and transaction details associated with each of the transactions. Following step 308, the installment qualification indication is sent to the issuer server 140 and the issuer server generates an indication which is sent to the cardholder 102. The indication may be sent as a text message, email message, or push message to an application running on the cardholder user device 160.

In step 310 which follows step 308, the installment platform server 150 deletes the grouped transaction from the transaction database 152. This ensures that a second installment qualification indication including the same transactions is not generated after further transactions are made by the cardholder 102 using the payment card 104. In some embodiments transactions may also be deleted from the transaction database 152 once the date and/or time of the transaction falls outside the time period over which transactions are grouped.

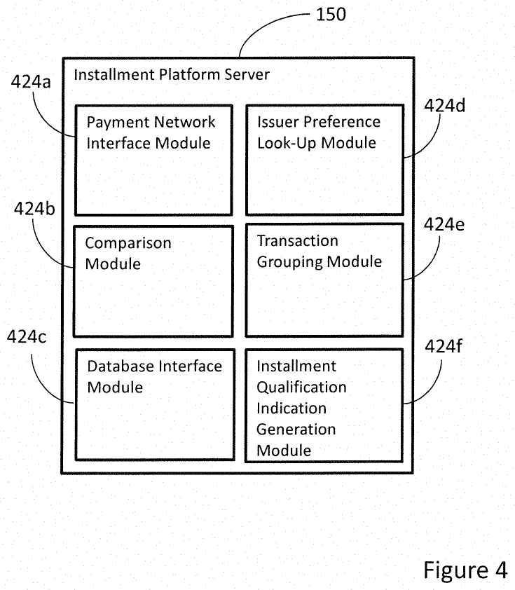

FIG. 4 is a block diagram showing a functional structure of an installment platform server according to an embodiment of the present invention. The functional structure of the installment platform server 150 comprises a payment network interface module 424a, a comparison module 424b, a database interface module 424c, an issuer preference look-up module 242d, a transaction grouping module 424e and an installment qualification generation module 424f.

The payment network interface module 424a is configured to enable the installment platform server 150 to communicate with the payment network server 130. The payment network interface module 424a allows the installment platform server 150 to receive transaction authorization requests transmitted over the payment network.

The comparison module 424b is configured to compare the transaction amount of payment transactions with the installment threshold. The installment threshold may be set by the issuer institution. In such embodiment, the comparison module 424b may receive an indication of the installment threshold for a specific issuer from the issuer preference look-up module 424d which is described in more detail below. The comparison module 424b is also configured to compare the group transaction amount for groups of transactions with the installment threshold.

The database interface module 424c carries out interactions with the transaction database 152. When a transaction amount is less than the installment threshold, the database interface module 424c stores an indication of the transaction in the transaction database 152. When the grouping operation is carried out by the transaction grouping module 424e, the database module 424c looks up transactions on which the grouping operation is to be performed. For example, the database module 424c may extract all transactions within a time period for a given payment card such that the transactions for that payment card can be grouped. The database interface module 424c may also be operable to delete transactions from the transaction database 152. This deleting may occur once a transaction has been included in a group of transactions that is eligible for payment by installments. Transactions may also be deleted from the transaction database 152 once the date and/or time of the transaction is outside of a certain period such that those transactions would not be included in future grouping operations.

The issuer preference look-up module 424d is configured to look up issuer preferences for such as an issuer specified installment threshold, and issuer specified grouping rules. An example of issuer specified information is described in more detail below with reference to FIG. 7. The issuer preference look-up module 424d uses an indication of the issuer institution to look-up the issuer specified information which is used by the other modules of the an installment platform server 150.

The transaction grouping module 424e performs the grouping operation. As described above, the grouping operation may be performed periodically, for example at the end of each day as a batch job. The transaction grouping module 424e groups transactions according to issuer specified rules which may be looked-up for each issuer by the issuer preference look-up module 424d.

The installment qualification indication generation module 424f generates an installment qualification for single transactions or groups of transactions if the transaction amount or group transaction amount is determined to be greater than or equal to the installment threshold by the comparison module 424b. Once the installment qualification indication generation module 424f has generated an installment qualification indication, it is send to the issuer server 140.

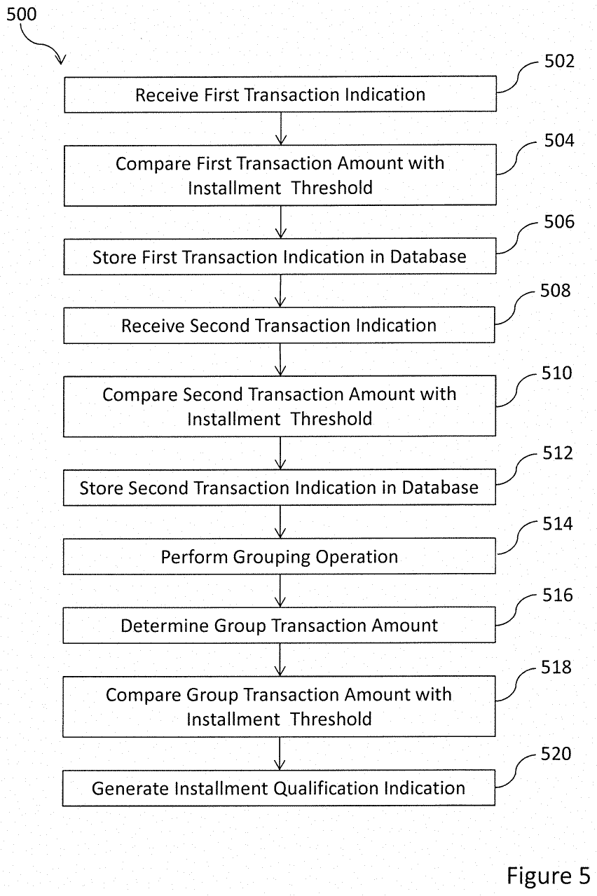

FIG. 5 is a flowchart showing a method of processing payment transaction indications to determine eligibility of a group of transactions for payment by installments according to an embodiment of the present invention. In the example shown in FIG. 5, the cardholder 102 makes a first transaction at a merchant using the payment card 104 for a transaction amount of USD 400 and then makes a second transaction at the same merchant at a later time on the same day for a transaction amount of USD 200. In this example, the installment threshold is USD 500. The method 500 is carried out by the installment platform server 150 shown in FIGS. 1 and 4.

In step 502, the payment network interface 424a of the installment platform server 150 receives a first transaction indication. The first transaction indication corresponds to a transaction for USD 400 made at a merchant by the cardholder 102 using the payment card 104.

In step 504, the comparison module 424b of the installment platform server 150 compares the transaction amount of the first transaction with the installment threshold. In some embodiments, the issuer preference look-up module 424d looks up an issuer specified installment threshold using an indication of the issuer of the payment card 104. In this example, the installment threshold is USD 500. Thus, in step 504, the comparison module 424b of the installment platform server 150 determines that the transaction amount is less than the installment threshold. Therefore the first transaction on its own does not qualify for payment by installments.

In step 506, the database module 424c of the installment platform server 150 stores an indication of the first transaction in the transaction database 152.

In step 508, the payment network interface 424a of the installment platform server 150 receives a second transaction indication. The second transaction indication corresponds to a transaction for USD 200 made at the same merchant as the first transaction by the cardholder 102 using the payment card 104.

In step 510, the comparison module 424b of the installment platform server 150 compares the transaction amount of the second transaction with the installment threshold. Since the installment threshold is USD 500, in step 510, the comparison module 424b of the installment platform server 150 determines that the transaction amount is less than the installment threshold. Therefore the second transaction on its own does not qualify for payment by installments.

In step 512, the database module 424c of the installment platform server 150 stores an indication of the second transaction in the transaction database 152.

In step 514, the transaction grouping module 424e of the installment platform server 150 performs a grouping operation. As described above, the grouping operation is a batch job performed at regular intervals as specified by the issuer institution. In this example, the grouping operation comprises grouping transaction made at the same merchant on the same day for a given payment card.

Thus, in this example, in step 514, the transaction grouping module 424e of the installment platform server 150 groups the first transaction and the second transaction since they were both carried out at the same merchant on the same day using the same payment card.

In step 516, the transaction grouping module 424e of the installment platform server 150 determines a group transaction amount for the group of transactions. The group transaction amount is determines as the sum of the individual transaction amounts for the transactions within the group. In this example, the group transaction amount is USD 600.

In step 518, the comparison module 424b of the installment platform server 150 compares the group transaction amount with the installment threshold. Since the installment threshold is USD 500, in step 518, the comparison module 424b of the installment platform server 150 determines that the group transaction amount is more than the installment threshold. Therefore the group of transactions qualifies for payment by installments.

In step 520, the installment qualification indication generation module 424f of the installment platform server 150 generates an installment qualification indication. The installment qualification indication is sent to the issuer server 140.

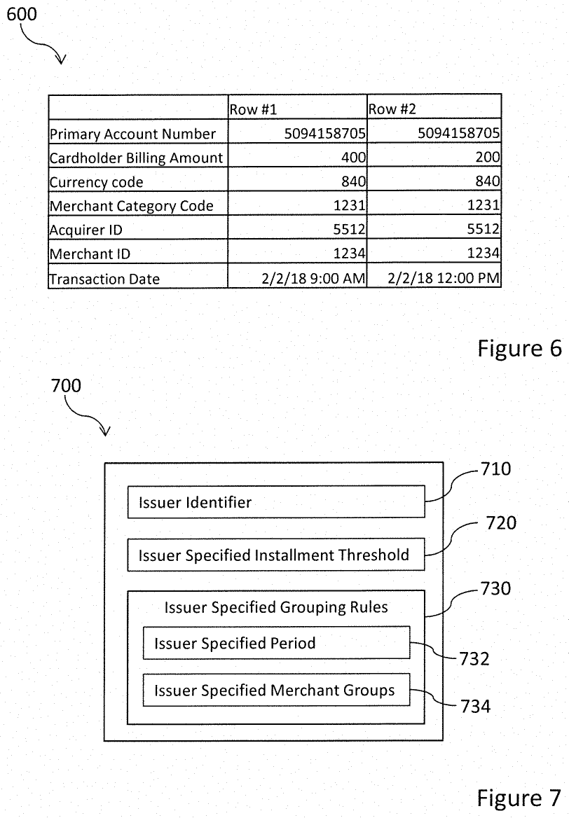

FIG. 6 shows an example of grouped transactions processed in the method described above with reference to FIG. 5. As shown in FIG. 6, the grouped transactions comprise the first transaction shown in Row #1 and the second transaction shown in Row #2. The information shown in FIG. 6 may be stored in the transaction database 152 and may form the installment qualification indication. As shown in FIG. 6, the information comprises an indication of the primary account number (PAN) of the payment card 104; an indication of the billing amount for each of the transactions; an indication of the currency; a merchant category code; an acquirer ID; a merchant ID and an indication of the transaction time and date.

It will be appreciated that two or more transactions may be grouped by the grouping operation to facilitate payment by installment. In the examples described above, for simplicity two transactions comprising a first transaction and a second transaction are described as being grouped by the grouping operation. However, further transactions, for example, a third transaction and a fourth transaction may also be included in the grouping operation such that the total amount of the grouped transactions is greater than or equal to the installment threshold.

FIG. 7 is a block diagram showing issuer specified information used in methods of determining eligibility of a group of transactions for payment by installments according to an embodiment of the present invention. As shown in FIG. 7, the user specified information 700 comprises an issuer identifier 710, an issuer specified installment threshold 720 and issuer specified grouping rules. The issuer identifier 710 may be used by the issuer preference look-up module 424d of the installment platform server 150 to retrieve the issuer specified information for an issuer. The issuer specified installment threshold indicates the installment threshold which is used by the comparison module 424b of the installment platform server 150 to determine whether individual transactions or groups of transaction qualify for payment by installments. The issuer specified grouping rules 730 comprise an issuer specified period 732 and issuer specified merchant groups 734. The issuer specified period indicates the period over which transactions may be grouped. The period may be for example 24 hours, 72 hours, one week or another period specified by the issuer institution. The issuer specified merchant groups 734 indicate merchants for which transactions may be included in the same group. This may indicate, for example, merchant identifiers for different outlets of the same chain of stores, merchant identifiers for different merchants within the same shopping mall, specific merchant categories which may be included in the same group, or other rules for grouping merchants as specified by the issuer institution.

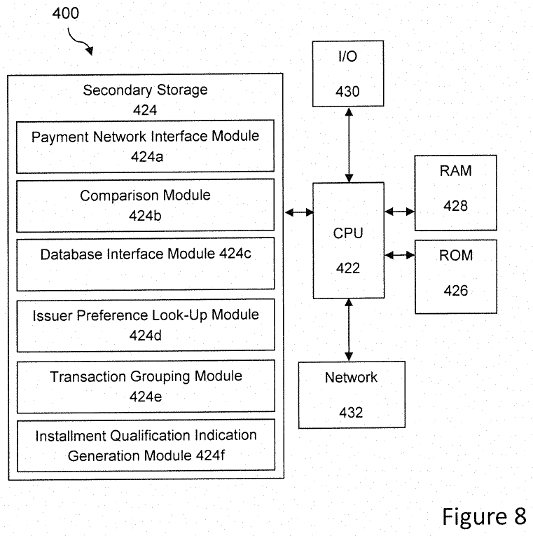

FIG. 8 is a block diagram showing a technical architecture of an installment platform server according to an embodiment of the present invention. The technical architecture 400 of the installment platform server 150 is for performing steps of exemplary methods described above. Typically, the methods are implemented by a number of computers each having a data-processing unit. The block diagram as shown in FIG. 8 illustrates a technical architecture 400 of a computer which is suitable for implementing one or more embodiments herein.

The technical architecture 400 includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture 400 may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution. In this embodiment, the secondary storage 424 has a payment network interface module 424a, a comparison module 424b, a database interface module 424c, an issuer preference look-up module 424d, a transaction grouping module 424e, and an installment qualification indication generation module 424f comprising non-transitory instructions operative by the processor 422 to perform various operations of the method of the present disclosure. As depicted in FIG. 8, the modules 424a-424f are distinct modules which perform respective functions implemented by the installment platform server 150. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 424a-424f is described herein, these may alternatively be implemented as one or more hardware modules (such as field-programmable gate array(s) or application-specific integrated circuit(s)) comprising circuitry which implements equivalent functionality to that implemented in software. The ROM 426 is used to store instructions and perhaps data which are read during program execution. The secondary storage 424, the RAM 428, and/or the ROM 426 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the method operations described herein. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 400, at least one of the CPU 422, the RAM 428, and the ROM 426 are changed, transforming the technical architecture 400 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 400 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 400 to provide the functionality of a number of servers that is not directly bound to the number of computers in the technical architecture 400. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Whilst the foregoing description has described exemplary embodiments, it will be understood by those skilled in the art that many variations of the embodiments can be made in accordance with the appended claims.

What is claimed is:

1. A data processing system for processing transaction data to determine eligibility of a group of transactions for payment by installments, the data processing system comprising:
a computer processor and a data storage device, the data storage device storing instructions operative by the processor to:
receive a first transaction indication, the first transaction indication indicating a first transaction on a payment card account and comprising an indication of the payment card account, an indication of a merchant, an indication of a transaction amount and an indication of a time and/or date of the first transaction;
compare the transaction amount of the first transaction with an installment threshold, the installment threshold indicating a minimum amount for a transaction to qualify for payment by installments;
store the first transaction indication in a database if the transaction amount of the first transaction is less than the installment threshold;
receive a second transaction indication, the second transaction indication indicating a second transaction on the payment card account and comprising an indication of the payment card account, an indication of a merchant, an indication of a transaction amount and an indication of a time and/or date of the second transaction;
compare the transaction amount of the second transaction with the installment threshold;
store the second transaction indication in a database if the transaction amount of the second transaction is less than the installment threshold;
perform a grouping operation, the grouping operation comprising, for all transaction indications stored in the database, grouping transactions for the payment card account which meet a grouping rule to form a transaction group;
determine a group transaction amount as a total of the transaction amounts of the transactions of the transaction group;
compare the group transaction amount with the installment threshold; and
generate an installment qualification indication comprising an indication of the group of transactions.

2. A data processing system according to claim 1, wherein the grouping rule comprises a time period wherein transactions having a transaction time and/or date within the time period are included in the transaction group.

3. A data processing system according to claim 1, wherein the grouping operation comprises grouping transactions according to a merchant identifier.

4. A data processing system according to claim 1, the grouping rule comprises an indication of a list of merchants, wherein transactions corresponding to merchants on the list of merchants are included in the transaction group.

5. A data processing system according to claim 1, wherein the data storage device stores instructions operative by the processor to determine an issuer of the payment card and look up a grouping rule and/or an installment threshold specified by the issuer of the payment card.

6. A data processing system according to claim 1, wherein the first transaction indication and the second transaction indication comprise transaction authorization responses.

7. A data processing system according to claim 1, wherein the data storage device stores instructions operative by the processor to send the installment qualification indication to a server associated with an issuer of the payment card.

8. A data processing system according to claim 1, wherein the data storage device stores instructions operative by the processor to delete indications of transactions included in the group of transactions from the transaction database.

9. A data processing system according to claim 1, wherein the data storage device stores instructions operative by the processor to delete indications of transactions from the transaction database if a time and/or date falls outside a time period over which transactions are grouped.

10. A data processing system according to claim 1, wherein the data storage device stores instructions operative by the processor to perform the grouping operation at regular intervals.

11. A method of processing transaction data, the method comprising:
receiving a first transaction indication, the first transaction indication indicating a first transaction on a payment card account and comprising an indication of the payment card account, an indication of a merchant, an indication of a transaction amount and an indication of a time and/or date of the first transaction;
comparing the transaction amount of the first transaction with an installment threshold, the installment threshold indicating a minimum amount for a transaction to qualify for payment by installments;
storing the first transaction indication in a database if the transaction amount of the first transaction is less than the installment threshold;
receiving a second transaction indication, the second transaction indication indicating a second transaction on the payment card account and comprising an indication of the payment card account, an indication of a merchant, an indication of a transaction amount and an indication of a time and/or date of the second transaction;
comparing the transaction amount of the second transaction with the installment threshold;
storing the second transaction indication in a database if the transaction amount of the second transaction is less than the installment threshold;
performing a grouping operation, the grouping operation comprising, for all transaction indications stored in the database, grouping transactions for the payment card account which meet a grouping rule to form a transaction group;
determining a group transaction amount as a total of the transaction amounts of the transactions of the transaction group;
comparing the group transaction amount with the installment threshold; and
generating an installment qualification indication comprising an indication of the group of transactions.

12. A method according to claim 11, wherein the grouping rule comprises a time period wherein transactions having a transaction time and/or date within the time period are included in the transaction group.

13. A method according to claim 11, wherein the grouping operation comprises grouping transactions according to a merchant identifier.

14. A method according to claim 11, wherein the grouping rule comprises an indication of a list of merchants, wherein transactions corresponding to merchants on the list of merchants are included in the transaction group.

15. A method according to claim 11 further comprising determining an issuer of the payment card and looking up a grouping rule and/or an installment threshold specified by the issuer of the payment card.

16. A method according to claim 11, wherein the first transaction indication and the second transaction indication comprise transaction authorization responses.

17. A method according to claim 11, further comprising sending the installment qualification indication to a server associated with an issuer of the payment card.

18. A method according to claim 11, further comprising deleting indications of transactions included in the group of transactions from the transaction database.

19. A method according to claim 11, wherein the grouping operation is performed at regular intervals.

20. A non-transitory computer-readable medium having stored thereon program instructions for causing at least one processor to perform the method according to claim 11.
